(19) United States
(12) Patent Application Publication
(10) Pub. No.: US 2008/0264980 A1
(43) Pub. Date: Oct. 30, 2008

(54) Liquid dispenser

(76) Inventor: Sylvain L'Ecuyer, Oka (CA)

Correspondence Address: Franz Bonsang;c/o EQUINOX PROTECTION, 410 - 1500, Du College, St-Laurent, QC, H4L 5G6, CA

(21) Appl. No.: 11/790,503

(22) Filed: Apr. 26, 2007

(51) Int. Cl. B67D 3/00

(52) U.S. Cl. 222/510; 222/484

(57) ABSTRACT

A liquid dispenser includes a container having a valved discharge outlet, the valve being actuable remotely by a screw cap of the container, which carries the valve stem. The valve stem is guided in usage during its linear travel between open and closed modes, the guidance being provided in the region of the discharge outlet by an apertured centre boss of a discharge grid.

### FIELD OF THE INVENTION

The present invention relates to a liquid dispenser and has particular reference to such a dispenser suitable for containing a liquid intended to be poured into a receptacle or reservoir by way of replenishment. The invention has especial, but not exclusive, reference for such a dispenser used for recharging automobile reservoirs with fresh liquids, for example water for the radiator and the engine cooling system, the windshield washer fluid for the appropriate reservoir, and others.

### BACKGROUND OF THE INVENTION

One of the problems associated with conventional dispensers is their use in filling other receptacles or reservoirs without spilling the liquids. Difficulty is generally encountered because of the distance needed to be bridged when upturning the dispenser to align its discharge outlet with the relevant charging reception port. Necessarily spillage occurs even when using a funnel or spout, especially in windy weather conditions or the like, the weight of the dispenser being another contributory factor to the problem.

It is already known to provide a dispenser with a valving arrangement for its discharge outlet whereby the liquid content is discharged only when the valve is opened following alignment of the discharge outlet with the charging port through which the liquid has to pass for use. U.S. Pat. No. 6,702,160 to Griffith is one example of such a dispenser and discloses a container having a valved dispensing port at one end of the dispenser aligned with a cap at the other end of the container carrying a valve stem with a valve head seating in and sealing the dispensing port. Opening of the cap by unscrewing the same occasions movement of the valve stem and unseating of the valve head thereby releasing liquid form the inside of the container through the dispensing port. Screwing down the cap is intended to reseat the valve and seal it to prevent further egress of liquid. One of the perceived disadvantages of this proposal is the lack of certainty associated with the effective reseating of the valve since continuity of linear movement of the valve stem is not guaranteed, thus giving rise to the possibility of a malfunction of the valve accompanied by undesirable leakage through the discharge outlet of the container.

Accordingly, there is a need for a liquid dispenser possessing improved features affording a greater degree of reliability of operation than has hitherto been possible with known designs.

### SUMMARY OF THE INVENTION

It is therefore a general object of the present invention to provide an improved liquid dispenser.

An advantage of the present invention is that the liquid dispenser is of simple construction and easy operation.

Another advantage of the present invention is that the liquid dispenser gives a more controlled discharge facility, and significantly reduces spillage.

According to a first aspect of the present invention there is provided a liquid dispenser comprising:
a container defining a liquid holding chamber having two ends, and surrounding walls integral with and interconnecting the said ends;
a port defined at one end of the container and a liquid discharge outlet defined at the other end of the container;
a tapering spout provided externally of the container and extending therefrom to define the discharge outlet, the spout defining a valve seating section therewithin;
a valve stem carrying a valve member for registration within the valve seating section, the valve stem extending from said valve member to the port;
a discharge grid disposed fixedly within the spout between the valve seating section and the discharge outlet, the grid being spaced from the valve seating section and providing a guide for the valve stem;
a cap provided for the port and adapted to locate and carry the valve stem; and
a stop associated with the valve stem to define the extent of movement thereof.

A recharging inlet for fresh liquid may additionally be provided in the same end as the port.

The cap is preferably of the screw type engaging a thread formed externally of the port.

The valve member may advantageously be of frusto-conical shape and provided with a seal, for example an O-ring inset in a groove in its tapered sealing face for mating with the valve seating section in the spout. The O-ring is of elastomeric material.

The discharge grid may be annular with a cruciform spider defining a central aperture guide for the valve stem. Conveniently, the central apertured boss includes an outwardly tapering aperture for insertion of the stop therethrough.

The stop is provided on the valve stem, conveniently at a location between the discharge grid and the outlet, whereby abutment of the stop with the grid limits linear movement of both the stem and thus the valve member in relation to the valve seating section of the spout.

Conveniently, the cap, the valve stem, the valve member and the stop are integrally formed out of one piece.

In one embodiment, the spout further extends downstream of the grid so as to contain the stop therein when the valve member sits onto the valve seating section of the spout. Conveniently, the spout further tapers when extending downstream of the grid so as to reduce spillage when dispensing liquid from the container.

The dispenser is advantageously produced from plastics material compatible with the liquids it is intended to contain. Conveniently the dispenser is reusable, and could also be recyclable.

The container may be formed with an integral carrying handle, which may be hollow and communicate with the rest of the container.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a side view of a liquid dispenser in accordance with an embodiment of the present invention partly cut-away to provide a sectional elevation of the inside of the dispenser, the dispenser being depicted in its normally upright storage position;

FIG. 2 is a side view of the liquid dispenser partly cut-away to provide a sectional elevation of the inside of the dispenser, the dispenser being depicted in an upended operational position in registration with a reservoir for discharge of its liquid contents; and

FIG. 3 is a sectional view on the line 3-3 of FIG. 2.

### DETAILED DESCRIPTION OF THE PREFERRED EMBODIMENTS

With reference to the annexed drawings the preferred embodiment of the present invention will be herein described for indicative purpose and by no means as of limitation.

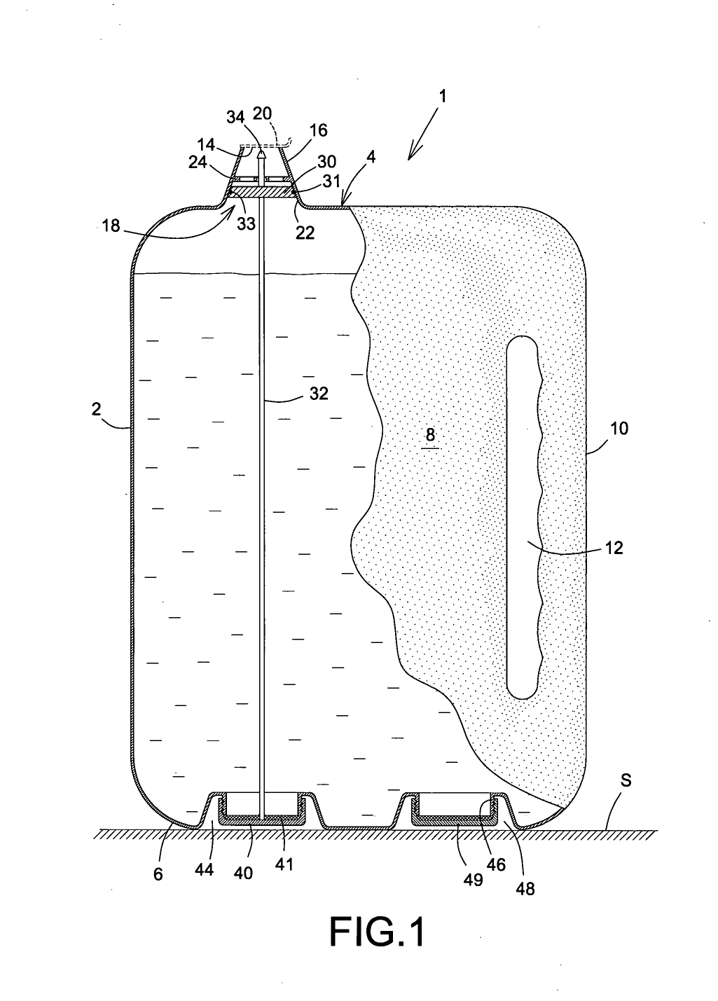

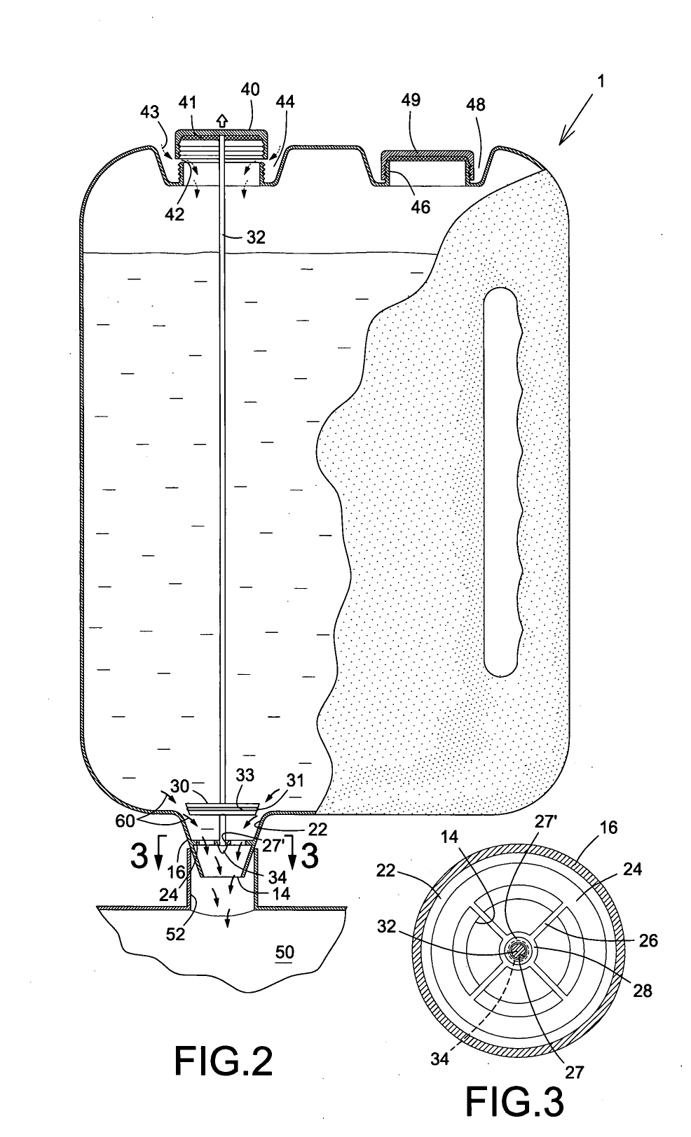

In FIGS. 1 and 2 there is shown a liquid dispenser 1 comprising a container 2 typically molded from a plastics material having two ends 4, 6 with sides 8, 10. The container is provided with an integral hollow handle 12 in at least one of the side walls 10.

A discharge outlet 14 is formed at the narrower end of a spout 16 extending from an opening 18 in end 4 of the container 2. A temporary foil seal 20 is shown covering the outlet 14 and is intended for removal and disposal upon first usage of the dispenser 1. The spout 16 defines therewithin a valve seating section 22 and also accommodates in fixed manner a discharge grid 24, which is annular and has a spider 26 with a central apertured boss 28.

A valve member 30 is carried on a valve stem 32 extending essentially the full depth of the container 2. The valve member 30 is typically of frusto-conical discoid form, similar to a drain plug, and is provided with typically an O-ring insert 31 set in a groove 33 for seating on and sealing with the valve seating section 22, as can be seen in FIG. 1. The valve stem 32 extends through the aperture 27 of the boss 28 of the spider 26 of the grid 24 and carries at its free end a stop 34, which in this example is conical. It will be readily understood that the stop 34 is of larger diametral extent than the boss aperture 27 and is intended in use to abut the same thereby to limit the movement of the valve stem 32 and thus the valve member 30. In order to ease the, typically snapping, insertion of the stop 34 through the aperture 27 from the inside of the container 2, the aperture 27 typically includes a tapered section 27′ substantially outwardly tapering.

Typically, the screw cap 40, the stem 32, the valve member 30 (except the sealing insert 31) and the stop 34 could be integrally formed out of one molded piece to easy assembly of the dispenser 1.

The valve stem 32 extends from the valve member 30 through the void of the container 2 and is carried by and affixed to a screw cap 40 engageable with a correspondingly externally-threaded necked opening 42 formed in end 6 of the container 2. A gasket 41 is provided in the cap 40 for sealing engagement with the opening 42. The necked opening 42 is conveniently recessed into the end 6 as at 44. A similar externally-threaded necked recharging inlet 46 is also formed in the end 6 and is also recessed therein as at 48, the inlet 46 being provided with a gasketed closure 49 a shown.

Typically, the opening 42 is large enough to allow the insertion of the valve member 30 there through.

In the storage position of the liquid dispenser 1 as shown in FIG. 1 the discharge outlet 14 is presented at the ‘top’ of the container 2, whilst the screw cap 40 and the inlet 46 are at the base of the container. It will be appreciated that the recessing at 44 and 48 allows the container 2 to assume a stable and upright storage condition on a supporting surface S.

When it is desired to replenish a reservoir 50, for example the windshield washer reservoir on a vehicle, the container 2 is inverted as shown in FIG. 2 such as to allow registration of the spout 16 within an inlet 52 on top of the reservoir 50. Once the spout 16 is positively located for flow communication in the inlet 52 the screw cap 40 is undone and in so doing the valve stem 32 and thus the valve member 30 ascend within the container 2 and the seal between the member 30 and the valve seating section 22 in the spout 16 is broken thus allowing flow of the liquid 60 from the container 2 via the outlet 14 through the inlet 52 into the reservoir 50. The elevation of the cap 40 allows ingress of air, as shown by arrows 43, to assist the flow of the liquid 60 which passes over the grid 24 into the frusto-conical section of the spout 16 giving a smooth and controlled flow, thus preventing or at least reducing spillage that could occur, especially because of the presence of the grid 24. The stop 34 on the valve stem 32 limits the travel of the valve member 30 and the guiding action of the discharge grid 24 with the stem 32 passing through its aperture 27 seeks to ensure linear movement of the stem.

Once sufficient replenishment of the reservoir 50 has been accomplished without spillage, the valve member 30 is reseated on the seating section 22 by screwing down the cap 40. The movement of the valve member 30 towards the seating is constrained in linear manner by the interaction of the valve stem 32 and the aperture 27 in the grid 34 as aforesaid and accordingly there is no tendency for the valve stem to wander. The valve member 30 thus seats positively on the seating to seal the discharge outlet 14 to prevent flow of the liquid and any seepage. The grid 24 is spaced from the seating section 22 as can be seen in FIG. 1 to ensure that in use the valve member does not inadvertently bottom on the grid thus giving rise to improper and ineffective seating resulting in leakage. Upon effective sealing of the outlet 14, the dispenser 1 may then be inverted to its original upright position as shown in FIG. 1.

The dispenser 1 may be replenished with fresh liquid through the recharging inlet 46 whilst the container is in the inverted position of FIG. 2, the closure 49 being securely tightened before the upright position is reassumed.

The dispenser of the present invention thus constitutes a useful contribution to the art in terms of providing positive guidance for the valve stem and thus the valve member to secure linear movement and therefore effective sealing to prevent seepage. Generally, the invention offers the user a simple means of refilling a reservoir by allowing accurate positioning of the container over the reservoir filling port, thus preventing wasteful and possibly costly spillage.

Although the opening port 42 is shown to be generally aligned with the discharge outlet 14, one skilled in the art would understand that the opening port could be offset (unaligned) relative to the discharge outlet, with a shaped stem extending there between, without departing from the scope of the present invention.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A liquid dispenser, comprising:
a container defining a liquid holding chamber having two ends, and surrounding walls integral with and interconnecting said ends;
a port defined at one end of the container and a liquid discharge outlet defined at the other end of the container;
a tapering spout provided externally of the container and extending therefrom to define the discharge outlet, the spout defining a valve seating section therewithin;
a valve stem carrying a valve member for registration within the valve seating section, the valve stem extending from said valve member to the port;
a discharge grid disposed fixedly within the spout between the valve seating section and the discharge outlet, the grid being spaced from the valve seating section and providing a guide for the valve stem;
a cap provided for the port and adapted to locate and carry the valve stem; and
a stop associated with the valve stem to define the extent of movement thereof.

2. The liquid dispenser of claim 1, wherein a recharging inlet is provided in the same end as the port.

3. The liquid dispenser of claim 1, wherein the cap is of the screw type adapted to engage a thread formed externally of the port.

4. The liquid dispenser of claim 1, wherein the valve member is of frusto-conical form and is provided with a seal inset in a groove in a tapered sealing face for mating with the valve seating section.

5. The liquid dispenser of claim 4, wherein the seal is an O-ring seal.

6. The liquid dispenser of claim 1, wherein the discharge grid is annular with a cruciform spider having a central apertured boss.

7. The liquid dispenser of claim 6, wherein the central apertured boss includes an outwardly tapering aperture for insertion of the stop therethrough.

8. The liquid dispenser of claim 1, wherein the stop is provided on the valve stem at a location between the discharge grid and the outlet, whereby in use abutment of the stop with the grid limits linear movement of the stem and the valve member in relation to the valve seating section of the spout.

9. The liquid dispenser of claim 1, wherein the cap, the valve stem, the valve member and the stop are integrally formed out of one piece.

10. The liquid dispenser of claim 1, wherein the spout further extends downstream of the grid so as to contain the stop therein when the valve member sits onto the valve seating section of the spout.

11. The liquid dispenser of claim 10, wherein the spout further tapers when extending downstream of the grid so as to reduce spillage when dispensing liquid from the container.

12. The liquid dispenser of claim 1, wherein the container is formed with an integral carrying handle.

13. The liquid dispenser of claim 1, wherein the container is produced from plastics material.

14. The liquid dispenser of claim 1, wherein the container is reusable.
